(19) United States
(12) Patent Application Publication
(10) Pub. No.: US 2015/0291911 A1
(43) Pub. Date: Oct. 15, 2015

(54) Triacylglycerol Based Composition

(71) Applicant: BATTELLE MEMORIAL INSTITUTE, Columbus, OH (US)

(72) Inventors: Ramanathan S. Lalgudi, Westerville, OH (US); Phillip N. Denen, Columbus, OH (US)

(73) Assignee: BATTELLE MEMORIAL INSTITUTE, Columbus, OH (US)

(21) Appl. No.: 14/685,960

(22) Filed: Apr. 14, 2015

Related U.S. Application Data
(60) Provisional application No. 61/979,466, filed on Apr. 14, 2014.

(51) Int. Cl. C11C 3/12; A23D 9/00; A23D 7/00; C11C 5/00; C09D 7/12

(52) U.S. Cl. CPC C11C 3/12; C11C 5/002; C09D 7/1233; A23D 7/00; A23D 9/00

(57) ABSTRACT

A candle includes candle wax and a wick disposed in the wax. The candle wax comprises a triacylglycerol component produced by partial hydrogenation of a triacylglycerol feedstock. The triacylglycerol feedstock has a monounsaturated fatty acid content of at least 22% and a polyunsaturated fatty acid content of not greater than 63%. The partially hydrogenated triacylglycerol component has a polyunsaturated fatty acid content of not greater than 3%.

### CROSS-REFERENCE TO RELATED APPLICATIONS

This application claims the benefit of U.S. Provisional Application No. 61/979,466, filed Apr. 14, 2014, the disclosure of which is incorporated herein by reference.

### BACKGROUND OF THE INVENTION

This invention relates in general to oils and fats and associated products, and in particular to improved triacylglycerol based compositions for use in candles, shortenings, margarines, coatings and other applications.

Triacylglycerols, also known as triglycerides or triacylglycerides, are the major component of plant oils and animal fats. Plant oils (or vegetable oils) are any of a large group of oils obtained from the seeds, fruits or leaves of plants. A triacylglycerol is a compound consisting of three fatty acids esterified to a glycerol. The fatty acids can differ in length and can be saturated (no carbon-carbon double bonds), mono-unsaturated (one carbon-carbon double bond), di-unsaturated or tri-unsaturated (both referred to as polyunsaturated). Some examples of typical fatty acids of plant oils are stearic, palmitic, oleic, linoleic and linolenic.

Partial hydrogenation of plant oils is carried out industrially to solidify the oil and make it amenable for use in shortenings, margarines, candles, coatings, inks and other applications. The partial hydrogenation process adds hydrogen atoms to the double bonds of unsaturated fatty acids, causing the fatty acids to become more saturated and the oil to become harder. In a kinetically well-controlled partial hydrogenation process the sequence of double bond conversion is linolenic (tri-unsaturated), linoleic (di-unsaturated) and oleic (mono-unsaturated). However, it is practically impossible to maintain the ideal kinetic behavior during the hydrogenation process. This deviation from ideal behavior results in a substantial amount of polyunsaturated fatty acids resulting from the partial hydrogenation of conventional plant oils.

The polyunsaturated plant oils are poorly suited for candles and many other industrial applications due to their poor thermal and oxidative stability. For example, partial hydrogenation of conventional soybean oil, when carried out to produce candle waxes, produces significant amounts of di-unsaturated fatty acids. This di-unsaturated fatty acid has inadequate thermo-oxidative stability and undergoes polymerization during candle burning. This eventually clogs the wicks and results in poor or non-burning of the candles. Candle manufactures mitigate the burn rate challenges by blending more than 60 wt % petroleum based waxes in combination with a larger wick diameter.

The partial hydrogenation of conventional plant oils also results in a substantial amount of trans fatty acids. These are unsaturated fatty acids having a trans configuration of carbon atoms adjacent to double bonds, which is different from the cis configuration in naturally occurring plant oils. The presence of trans fatty acids makes the vegetable oils undesirable for food applications because of their associated health risks.

The patent literature discloses examples of developments to improve the properties of plant oil compositions for different applications. For example, U.S. Pat. No. 6,238,926 by Liu et al, assigned to Cargill, describes a process for modifying a triacylglycerol stock, such as a vegetable oil stock, to better control fluidity. The process includes interesterifying the triacylglycerol stock in the presence of a basic catalyst while monitoring the absorbance of the reaction mixture.

A series of patents by Murphy et al, assigned to Cargill, describe a triacylglycerol-based wax for use in candle making. The wax includes a triacylglycerol component in combination with a polyol ester component, or a triacylglycerol component having a specified fatty acid profile. See, for example, U.S. Pat. Nos. 6,503,285; 6,645,261; 6,770,104; 6,773,469; 6,797,020; 7,128,766 and 7,217,301.

Additionally, the patent literature discloses examples of plant oils having improved properties and/or having fatty acid compositions that are different from conventional plant oils. For example, U.S. Pat. No. 5,981,781 by Knowlton, assigned to DuPont, describes a high oleic soybean oil having high oxidative stability. DuPont sells a high oleic soybean oil under the brand name Plenish®.

U.S. Pat. No. 5,885,643 by Kodali et al, assigned to Cargill, describes hydrogenated canola oils having relatively low levels of trans fatty acids and saturated fatty acids, yet having improved oxidative stability.

It would be desirable to provide improved triacylglycerol based compositions for use in candles, shortenings, margarines, coatings and other applications. In particular, it would be desirable to provide triacylglycerol based compositions that have high oxidative stability and that are low in polyunsaturated fatty acids and trans fatty acids.

### SUMMARY OF THE INVENTION

A candle includes candle wax and a wick disposed in the wax. The candle wax comprises a triacylglycerol component produced by partial hydrogenation of a triacylglycerol feedstock. The triacylglycerol feedstock has a monounsaturated fatty acid content of at least 22% and a polyunsaturated fatty acid content of not greater than 63%. The partially hydrogenated triacylglycerol component has a polyunsaturated fatty acid content of not greater than 3%.

A triacylglycerol based composition includes a triacylglycerol component produced by full hydrogenation of a triacylglycerol feedstock. A softener is blended with the triacylglycerol component to decrease the hardness of the triacylglycerol based composition. The softener is an oil which is a monoglyceride, diglyceride or triglyceride, the oil having fatty acids which are saturated or mono-unsaturated. The triacylglycerol based composition has a saturated fatty acid content within a range of 20% to 30% and a monounsaturated fatty acid content within a range of 60% to 80%.

Various aspects of this invention will become apparent to those skilled in the art from the following detailed description of the preferred embodiment, when read in light of the accompanying drawings.

### BRIEF DESCRIPTION OF THE DRAWINGS

FIGS. 1-3 relate to an experiment described in Example 16, which investigates the solid fat content and penetration properties of different blends of fully hydrogenated soybean oil and high oleic soybean oil.

FIG. 1A shows a cone of penetrometry used in the experiment. FIG. 1B is a plot of force as a function of depth of penetration into the blend.

FIG. 2 is a plot of the solid fat content profiles of the blends and a control margarine.

FIG. 3A is a plot of penetration force as a function of penetration depth for the crystallized blends and control margarine. FIG. 3B is a graph comparing the hardness of the blends and the control margarine.

### DETAILED DESCRIPTION OF THE PREFERRED EMBODIMENT

The present invention relates to improved triacylglycerol based compositions. In a first embodiment, the composition comprises a triacylglycerol component produced by partial hydrogenation of a triacylglycerol feedstock. The triacylglycerol feedstock has a monounsaturated fatty acid content of at least 22% and a polyunsaturated fatty acid content of not greater than 63%. The partially hydrogenated triacylglycerol component has a polyunsaturated fatty acid content of not greater than 3%.

In certain embodiments, the partially hydrogenated triacylglycerol component has a saturated fatty acid content within a range from 20% to 30% and a monounsaturated fatty acid content within a range from 70% to 80%.

Also, in certain embodiments, the triacylglycerol feedstock has a polyunsaturated fatty acid content of not greater than 10%, more particularly not greater than 8%, and most particularly about 6% or less.

In certain embodiments, the partially hydrogenated triacylglycerol component has a diunsaturated fatty acid content of not greater than 2% and a triunsaturated fatty acid content of not greater than 1%.

The feedstock can be any type of triacylglycerol having the above-described fatty acid content, including any type of plant oil, algal oil, animal fat or synthetically produced oil. Some nonlimiting examples of plants from which oils can be derived include soybean, canola, palm, olive, peanut, sesame, sunflower and safflower. Combinations of different oils can also be used. In certain embodiments, the triacylglycerol feedstock comprises a high oleic oil. For example, the oil may have an oleic acid content of at least 60%, at least 70%, or in certain embodiments about 80%. In a particular embodiment, the oil is a high oleic soybean oil.

Conventional plant oils have lower levels of oleic acid, which is mono-unsaturated, and higher levels of polyunsaturated fatty acids such as linoleic and linolenic acids. Recently, DuPont developed a high oleic variety of the soybean plant and has been marketing high oleic soybean oil under the brand name Plenish®. This oil has a fatty acid composition of approximately 8% palmitic, 4% stearic, 80% oleic, 3% linoleic and 3% linolenic. If available, other types of high oleic soybean oils and other plant oils can also be used.

The fatty acid composition of the triacylglycerol can be measured by any suitable method. For example, the well known gas chromatography-mass spectrometry (GC-MS) method involves a first step of preparing fatty acid methyl esters (FAME) from the triacylglycerol, often by hydrolysis or methylation, and a second step of quantifying the fatty acid methyl esters by GC-MS. Other known methods include the application of high performance liquid chromatography-mass spectrometry, high performance size exclusion chromatography and nuclear magnetic resonance.

The triacylglycerol feedstock is partially hydrogenated to produce the triacylglycerol component. Partially hydrogenated fats and oils are limited in degree of hydrogenation, as compared to completely or fully hydrogenated fats and oils. Light to moderate hydrogenation results in limited increases in melting properties while improving stability. A fully hydrogenated fat or oil, on the other hand, is a fat or oil that has been hydrogenated to the completion or near completion of saturation, which results in significant chemical and physical changes such as transformation of liquids to solids at room temperature and increase in melt point, solid content, saturation and stability.

The triacylglycerol feedstock can be partially hydrogenated by any suitable method and using any suitable equipment. Hydrogenation is the reaction of adding hydrogen atoms to the carbon-carbon double bonds in unsaturated fatty acids. The hydrogenation process typically involves sparging the fat or oil at high temperature and pressure with hydrogen in the presence of a catalyst. For example, the hydrogenation may be conducted at a temperature within a range of from 100° C. to 270° C. at a pressure within a range of from 20 psig to 100 psig. Different types of industrial hydrogenation reactors are known including, for example, tubular plug-flow reactors packed with a supported hydrogenation catalyst. Also, different types of hydrogenation catalysts are known including, for example, transition metals such as Ni, Cu, Zn, Pd, Pt Au and Ag. Processes and equipment for hydrogenating fats and oils are described in Bailey's Industrial Oil and Fat Products, Sixth Edition, published by Wiley Interscience (2005).

The triacylglycerol component after partial hydrogenation has a polyunsaturated fatty acid content of not greater than 3%. In certain embodiments, it has a polyunsaturated fatty acid content of not greater than 2%, and more particularly not greater than 1%. In some embodiments it has a polyunsaturates content of about 0%. The low levels of polyunsaturates improve the thermal and oxidative stability of the composition. Earlier known partially hydrogenated triacylglycerol compositions do not have such low levels of polyunsaturates.

The triacylglycerol based composition can fill unmet industrial needs for compositions with low levels of polyunsaturates. For example, the composition can provide the candle industry with a soy based wax having low levels of linoleic and linolenic fatty acids. The wax will not only improve candle burning performance, it will also allow manufacturers to eliminate the blending of a petroleum wax with the soy wax in the candles. As another example, the composition can be used to produce a margarine or other food having a low level of polyunsaturates. The polyunsaturates in a food can produce trans fatty acids when the food is fried or otherwise heated, and thus a food having a lower level of polyunsaturates before heating can result in a more healthful food having lower trans fatty acids.

In certain embodiments, the partially hydrogenated triacylglycerol component has a fatty acid composition of 10-20% stearic, 5-15% palmitic, 50-80% oleic, 0.1-2% linoleic and 0.1-1% linolenic.

In certain embodiments, the partially hydrogenated triacylglycerol component has an iodine value within a range of from 45 to 70. The iodine value or “IV” is a measure of the total number of unsaturated double bonds present in a fat or oil. The iodine value can be measured by any suitable method; for example, by AOCS Official Method Cd 1d-92, “Iodine Value of Fats and Oils Cyclohexane-Acetic Acid Method,” which measures centigrams of iodine absorbed per gram of test sample.

In certain embodiments, the partially hydrogenated triacylglycerol component has a melting temperature within a range from 0° C. to 70° C. and a crystallization temperature within a range from −15 ° C. to 45° C. The melting temperature and crystallization temperature can be measured by any suitable method; for example, by the use of differential scanning calorimetry (DSC), which measures the amount of heat absorbed or released during phase transitions of the sample.

In certain embodiments, the partially hydrogenated triacylglycerol component has a softness index within a range from 0.005 pound-force (lbf) to 0.505 pound-force (lbf). The softness index can be measured by any suitable method.

In a second embodiment, the triacylglycerol based composition comprises a triacylglycerol component produced by full hydrogenation of a triacylglycerol feedstock, and a softener blended with the triacylglycerol component to decrease the hardness of the triacylglycerol based composition.

The triacylglycerol based composition has a saturated fatty acid content within a range of 20% to 30% and a monounsaturated fatty acid content within a range of 60% to 80%.

In certain embodiments, the triacylglycerol feedstock before hydrogenation has an oleic acid content of at least 60%, a saturated fatty acid content of not greater than 30%, and a polyunsaturated fatty acid content of not greater than 10%. Also, in certain embodiments, the triacylglycerol feedstock comprises a high oleic plant oil derived from soybean, canola, palm, olive, peanut, sesame, sunflower, safflower or others. In certain embodiments, the triacylglycerol feedstock has an oleic acid content of at least 75% and a polyunsaturates content of not greater than 8%.

The softener is an oil which is a monoglyceride, diglyceride or triglyceride. Substantially all the fatty acids of the oil are saturated or mono-unsaturated.

In this manner, the second embodiment provides a triacylglycerol composition having a malleability and ductility suitable for use in producing candles, shortenings, margarines, coatings and other applications, while also having a high oxidative stability and a low level of polyunsaturated fatty acids.

The triacylglycerol feedstock can be any suitable type of plant oil, algal oil, animal fat, petroleum derived triacylglycerol, or other type of synthetic triacylglycerol. It may be a conventional oil or fat. Such triacylglycerols are well known in the fats and oils industry. For specific examples, reference can be made to the above-mentioned Bailey's Industrial Oil and Fat Products.

The triacylglycerol feedstock is fully hydrogenated to produce the triacylglycerol component. Generally, the hydrogenation process is conducted as described above for partial hydrogenation but for a longer time or under higher pressure and/or temperature to achieve substantially complete hydrogenation of the triacylglycerol feedstock. The triacylglycerol feedstock can be measured for iodine value during the process to determine the degree of completion of the hydrogenation. In certain embodiments, the fully hydrogenated triacylglycerol component has an iodine value within a range from 0 to 5.

As mentioned above, the softener is blended with the fully hydrogenated triacylglycerol feedstock and it decreases the hardness of the overall triacylglycerol based composition. In certain embodiments, the softener decreases the hardness of the composition by an amount within a range of 5% to 50%, compared with the hardness of the fully hydrogenated triacylglycerol feedstock alone.

The softener is an oil which is a monoglyceride, diglyceride or triglyceride. In certain embodiments, the softener comprises a short chain triglyceride, by which is meant triglycerides having fatty acid chains of 5 or less carbon atoms. Some nonlimiting examples of short chain triglycerides include triacetin, tributyrin, tripropionin, and combinations thereof.

In certain embodiments, the softener comprises a fatty acid ester. Some nonlimiting examples of fatty acid esters include ethylhexyl stearate, ethylhexyl palmitate, ethylhexyl laurate, and combinations thereof.

In other embodiments, the softener comprises a high oleic plant oil that is not hydrogenated. This can include any of the plant oils mentioned above or others.

In certain embodiments, the softener comprises a plant oil derivative. Some examples of plant oil derivatives include methyl soyate and epoxidized soybean oil. Combinations of any of the above-mentioned softeners can also be used.

The softener and the fully hydrogenated triacylglycerol component can be blended together in any suitable amounts. In certain embodiments, the triacylglycerol based composition comprises the triacylglycerol component in an amount from 30% to 95.5% and the softener in an amount from 0.5% to 90% by weight of the composition. In some particular embodiments, the triacylglycerol based composition comprises the softener in an amount from 35% to 80% by weight of the composition, and more particularly from 60% to 80%.

In certain embodiments, the triacylglycerol based composition has a trans fatty acid content of not greater than 0.5%. For example, in certain embodiments, the composition is produced by taking a fully hydrogenated soybean oil, which is a hard wax with no trans fat in it, and blending it with a high oleic soybean oil, with no trans fat in it, to make a product having a consistency suitable for candles, margarines, and other applications.

In certain embodiments, the fully hydrogenated triacylglycerol component has a fatty acid composition of 75-90% stearic and 10-25% palmitic. Also, in certain embodiments, the triacylglycerol based composition (including the softener blended with the fully hydrogenated triacylglycerol component) has a fatty acid composition of 10-20% stearic, 5-15% palmitic, 50-80% oleic, 1-10% linoleic and 0.1-5% linolenic.

In certain embodiments, the fully hydrogenated triacylglycerol component has a melting temperature within a range from 45° C. to 75° C. and a crystallization temperature within a range from 20° C. to 50° C. Also, in certain embodiments, the triacylglycerol based composition has a melting temperature within a range from 10° C. to 75° C. and a crystallization temperature within a range from −5° C. to 50° C.

In certain embodiments, the fully hydrogenated triacylglycerol component has a softness index within a range from 0.011 lbf to 13.516 lbf and the triacylglycerol based composition has a softness index within a range from 4 lbf to 5 lbf.

The triacylglycerol based compositions of the invention may be useful in many different applications, such as candles, other wax products, shortenings, margarines, coatings (e.g., corrugated board coatings), toners, inks, and others.

A candle produced from the triacylglycerol based composition can be of any size and shape desired. The candle may include a wick which typically extends longitudinally from one end of the candle to the other end. The wick can be made from woven cotton or any other suitable material as known in the art. The candle may also include minor amounts of other additives to modify the properties of the waxy material. Examples of types of additives which may be incorporated include colorants, fragrances (e.g., fragrance oils), insect repellants and migration inhibitors.

The candles may be formed by a method which includes heating the triacylglycerol based wax to a molten state and introducing the molten wax into a mold which includes a wick disposed therein. The molten triacylglycerol based wax is cooled in the mold to solidify the wax and the solidified wax is removed from the mold. Other candle production methods and materials may also be used.

The candle burn rate and the fragrance throw can be improved with candles produced by the present invention compared with candles produced with conventional soybean oil. The candles can also be less susceptible to oxidation. The processing time can be less than that of a conventional hydrogenation process to produce candle wax.

### EXAMPLES

The invention is further illustrated with the following examples:

### Example 1

### Partial Hydrogenation of Plenish®

2792.91 g Plenish® and 5.26 g of Ni on alumina/silica were charged to a 5 liter stainless steel pressure reactor equipped with a mechanical stirrer, a thermocouple, argon inlet, a hydrogen inlet, and a vent tube. The head space in the reactor was flushed with argon for 10 minutes to rid any oxygen containing air. While the head space was being flushed with argon, the Plenish® was heated to 180° C. while stirring at 350 rpm. Once the Plenish® reaches 180° C. the reactor was pressurized with hydrogen to 200 psi. The IV of the Plenish® was checked regularly during the hydrogenation and the reaction was stopped once the IV reaches between 45-70. The reaction was complete in 1 hour 47 minutes.

### Example 2

### Partial Hydrogenation of Plenish®

2817.67 g Plenish® and 5.33 g of Pd on carbon were charged to a 5 liter stainless steel pressure reactor equipped with a mechanical stirrer, a thermocouple, argon inlet, a hydrogen inlet, and a vent tube. The head space in the reactor was flushed with argon for 10 minutes to rid any oxygen containing air. While the head space was being flushed with argon, the Plenish® was heated to 180° C. while stirring at 350 rpm. Once the Plenish® reaches 180° C. the reactor was pressurized with hydrogen to 200 psi. The IV of the Plenish® was checked regularly during the hydrogenation and the reaction was stopped once the IV reaches between 45-70. The reaction was complete in 31 minutes.

### Example 3

### Partial Hydrogenation of Plenish®

150.06 g Plenish® and 0.43 g of Ni on alumina/silica were charged to a 300 milliliter stainless steel pressure reactor equipped with a mechanical stirrer, a thermocouple, argon inlet, a hydrogen inlet, and a vent tube. The head space in the reactor was flushed with argon for 10 minutes to rid any oxygen containing air. While the head space was being flushed with argon, the Plenish® was heated to 160-170° C. while stirring at 350 rpm. After the 10 minutes of headspace flushing was finished, the reactor was pressurized with hydrogen to 88 psi. The pressure was maintained between 66-100 psi during the reaction. The IV of the Plenish® was checked regularly during the hydrogenation and the reaction was stopped once the IV reaches between 45-70. The reaction was complete in 5 hours 20 minutes.

### Example 4

### Partial Hydrogenation of Plenish®

149.99 g Plenish® and 0.29 g of Pd on carbon were charged to a 300 milliliter stainless steel pressure reactor equipped with a mechanical stirrer, a thermocouple, argon inlet, a hydrogen inlet, and a vent tube. The head space in the reactor was flushed with argon for 10 minutes to rid any oxygen containing air. While the head space was being flushed with argon, the Plenish® was heated to 160° C. while stirring at 350 rpm. After the 10 minutes of headspace flushing was finished, the reactor was pressurized with hydrogen to 200 psi. The pressure was maintained between 100-200 psi during the reaction. The IV of the Plenish® was checked regularly during the hydrogenation and the reaction was stopped once the IV reaches between 45-70. The reaction was complete in 1 hour 31 minutes.

### Example 5

### Full Hydrogenation of Plenish®

3070.8 g Plenish® and 5.50 g of Ni on alumina/silica were charged to a 5 liter stainless steel pressure reactor equipped with a mechanical stirrer, a thermocouple, argon inlet, a hydrogen inlet, and a vent tube. The head space in the reactor was flushed with argon for 10 minutes to rid any oxygen containing air. While the head space was being flushed with argon, the Plenish® was heated to 180° C. while stirring at 350 rpm. Once the Plenish® reaches 180° C. the reactor was pressurized with hydrogen to 200 psi. The IV of the Plenish® was checked regularly during the hydrogenation and the reaction was stopped once the IV reached 0. The reaction was complete in 5 hours 19 minutes.

### Example 6

### Full Hydrogenation of Plenish®

150.01 g Plenish® and 0.31 g of Pd on carbon were charged to a 300 milliliter stainless steel pressure reactor equipped with a mechanical stirrer, a thermocouple, argon inlet, a hydrogen inlet, and a vent tube. The head space in the reactor was flushed with argon for 10 minutes to rid any oxygen containing air. While the head space was being flushed with argon, the Plenish® was heated to 160° C. while stirring at 350 rpm. After the 10 minutes of headspace flushing was finished, the reactor was pressurized with hydrogen to 184 psi. The pressure was maintained between 108-493 psi during the reaction. The IV of the Plenish® was checked regularly during the hydrogenation and the reaction was stopped once the IV fell reached 0. The reaction was complete in 1 hour 54 minutes.

### Example 7

### Full Hydrogenation of Plenish®

150.00 g Plenish® and 0.31 g of Ni on alumina/silica were charged to a 300 milliliter stainless steel pressure reactor equipped with a mechanical stirrer, a thermocouple, argon inlet, a hydrogen inlet, and a vent tube. The head space in the reactor was flushed with argon for 10 minutes to rid any oxygen containing air. While the head space was being flushed with argon, the Plenish® was heated to 160° C. while stirring at 350 rpm. After the 10 minutes of headspace flushing was finished, the reactor was pressurized with hydrogen to 197 psi. The pressure was maintained between 197-497 psi during the reaction. The IV of the Plenish® was checked regularly during the hydrogenation and the reaction was stopped once the IV reached 0. The reaction was complete in 2 hours 26 minutes.

### Example 8

### Full Hydrogenation of RBD Oil

2809.71 g RBD oil and 5.35 g of Ni on alumina/silica were charged to a 5 liter stainless steel pressure reactor equipped with a mechanical stirrer, a thermocouple, argon inlet, a hydrogen inlet, and a vent tube. The head space in the reactor was flushed with argon for 10 minutes to rid any oxygen containing air. While the head space was being flushed with argon, the RBD oil was heated to 180° C. while stirring at 350 rpm. Once the RBD oil reaches 180° C. the reactor was pressurized with hydrogen to 200 psi. The IV of the RBD oil was checked regularly during the hydrogenation and the reaction was stopped once the IV reached 0. The reaction was complete in 7 hour 15 minutes.

### Example 9

### Full Hydrogenation of RBD Oil

149.97 g RBD oil and 0.29 g of Ni on alumina/silica were charged to a 300 milliliter stainless steel pressure reactor equipped with a mechanical stirrer, a thermocouple, argon inlet, a hydrogen inlet, and a vent tube. The head space in the reactor was flushed with argon for 10 minutes to rid any oxygen containing air. While the head space was being flushed with argon, the RBD oil was heated to 160° C. while stirring at 350 rpm. After the 10 minutes of headspace flushing was finished, the reactor was pressurized with hydrogen to 171 psi. The pressure was maintained between 171-522 psi during the reaction. The IV of the RBD oil was checked regularly during the hydrogenation and the reaction was stopped once the IV reached 0. The reaction was complete in 3 hours 36 minutes.

### Example 10

### Full Hydrogenation of RBD Oil

150.01 g RBD oil and 0.30 g of Pd on carbon were charged to a 300 milliliter stainless steel pressure reactor equipped with a mechanical stirrer, a thermocouple, argon inlet, a hydrogen inlet, and a vent tube. The head space in the reactor was flushed with argon for 10 minutes to rid any oxygen containing air. While the head space was being flushed with argon, the RBD oil was heated to 160° C. while stirring at 350 rpm. After the 10 minutes of headspace flushing was finished, the reactor was pressurized with hydrogen to 215 psi. The pressure was maintained between 215-485 psi during the reaction. The IV of the RBD oil was checked regularly during the hydrogenation and the reaction was stopped once the IV reached 0. The reaction was complete in 7 hours 3 minutes.

### Example 11

### Mixing Additives with Fully Hydrogenated RBD Oil

119.99 g RBD oil, 29.99 g of ester of methyl oleate and 2-ethyl-1-hexanol and 0.33 g of Ni on alumina/silica were charged to a 300 milliliter stainless steel pressure reactor equipped with a mechanical stirrer, a thermocouple, argon inlet, a hydrogen inlet, and a vent tube. The head space in the reactor was flushed with argon for 10 minutes to rid any oxygen containing air. While the head space was being flushed with argon, the reaction mixture was heated to 180° C. while stirring at 350 rpm. Once the RBD oil reaches 180° C. the reactor was pressurized with hydrogen to 780 psi. The IV of the RBD oil was checked regularly during the hydrogenation and the reaction was stopped once the IV reached 0. The reaction was complete in 8 hours 15 minutes.

### Example 12

### Mixing Additives with Fully Hydrogenated Plenish® or RBD Oil

40 g of fully hydrogenated oil was added to a 125 ml glass jar. The additive was placed in a separate 60 ml jar. Both jars containing the additive and the wax were placed in an 80° C. oven to melt/warm. After the wax was fully melted, 10 g of the additive selected from triacetin, tributyrin, 2-ethyl hexyl stearate, 2-ethyl hexyl palmate, 2-ethyl hexyl laurate, and high oleic oil (Plenish®) was added to the melted wax and mixed well for 30 seconds followed by cooling to room temperature to obtain the product.

### Example 13

### Making Candle Formulations from Example 1 through 12

This formulation is to make a 3 ounce votive candle (˜60 g of wax per candle). A double-sided wick tape was used to place and hold the wick in the center of the votive. The wick tape was used to tape the wick to the glass. A total of 200 g of wax and/or the additive were placed in a 2 liter Nalgene® bottle. The bottle and the votive were placed in an 80° C. oven to melt the wax. Once all of the wax has melted, the wax was poured into the hot votive. A wick bar was used to ensure that the wicks remain taut and centered in the wick. The candle was placed in the hood and allowed to slowly cool overnight.

Melting and crystallization behavior of the waxes produced in Examples 1-11 were determined using Dynamic Scanning Calorimetric and are presented in the following table:

| | | Crystallization |
|---|---|---|
| Example | Melt Peaks (° C.) | Peak (° C.) |
| 1 | 6.8, 23.11, 45.87, 53.46 | 24.89, 4.05, −10.56 |
| 2 | 25.27 | 23.21, 7.52 |
| 3 | 50.86 | 30.66 |
| 4 | N/A | N/A |
| 5 | N/A | N/A |
| 6 | N/A | N/A |
| 7 | 55.12, 64.42, 68.33 | 45.68 |
| 8 | 53.59, 66.25 | 44.02 |
| 9 | 51.71, 62.08 | 45.82, 26.41 |
| 10 | N/A | N/A |
| 11 | 17.79, 47.13, 54.53 | 42.34, 14.78, 0.43 |

### Example 14

### Producing a Blend of Fully Hydrogenated Soybean Oil (“Wax”) and High Oleic Soybean Oil

Charge 25 g of fully hydrogenated soy wax to a 100 ml flask equipped with a mechanical stirrer, a thermocouple, and an argon inlet. Heat the wax to 80° C. to melt. Once the wax is completely melted, slowly charge 25 g of high oleic soybean oil to the melted wax. Once the oil has been completely added, stir for an additional 10 minutes.

### Example 15

### Producing a Different Blend of Fully Hydrogenated Soybean Oil (“Wax”) and High Oleic Soybean Oil

Charge 45 g of high oleic soybean oil to a 100ml flask equipped with a mechanical stirrer, a thermocouple, and an argon inlet. Heat the oil to 80° C. Once the oil is 80° C., slowly charge 5 g of fully hydrogenated soy wax. Once the wax has been completely melted, stir for an additional 10 minutes.

Melt peaks (by DSC) and crystallization peaks of different blends of high oleic soybean oil and fully hydrogenated soybean oil (“wax”) are presented in the following table:

| | % High Oleic | | Crystal. P. |
|---|---|---|---|
| Sample | Soybean Oil | Melt Peaks (° C.) | (° C.) |
| A | 0 | 53.38, 64.34 | 45.37 |
| B | 5 | −15.66, 60.78, 68.04 | 46.16 |
| C | 10 | −15.34, 68.88 | 44.62 |
| D | 20 | −16.29, 66.67 | 45.33 |
| E | 30 | −16.29, −6.78, 65.83 | 43.5 |
| F | 40 | −15.88, −6.12, 65.76 | 41.82 |
| G | 50 | −16.37, −6.46, 64.09 | 41.81 |
| H | 70 | −16.14, −6.47, 61.39 | 38.14 |

### Example 16

Investigating the solid fat content and penetration properties of different blends of fully hydrogenated soybean oil and high oleic soybean oil.

Experiment Description:

This experiment aims to explore the possibility of making margarine from a binary mixture of fully hydrogenated soybean oil (FHSO) and high oleic soybean oil (HOSO). This includes preparation of five different possible formulations and evaluation of their hardness and solid fraction as a function of temperature. Details of the performed analysis are provided below:

Experiment Design and Experimental Plan:

Materials: Fully hydrogenated soybean oil and high oleic soybean oil were provided by Battelle Memorial Institute (Columbus, Ohio). As a control, a commercial margarine (made from partially hydrogenated canola oil and partially hydrogenated soybean oil) was purchased from a local grocery store.

Blends Preparation: Six different concentrations of fully hydrogenated soybean oil and high oleic soybean oil were prepared. FHSO was diluted with HOSO in 5% increments from 20% to 45% (w/w). The mixtures were heated to 80° C. in an oven and held at this temperature for 15 min to erase the crystal memory. All the blends were crystallized from 80° C. to 20° C. at a cooling rate of approximately 5° C./min. Crystallized samples were stored for 24 hours in an incubator (set at 20° C.) before further analysis.

Solid Fat Content Measurements: The solid fat content (SFC) was measured by means of pulsed nuclear magnetic resonance (p-NMR) using a Bruker Minispec® spectrometer (Bruker Optics Ltd., Ontario, Canada). Glass NMR tubes (10 mm diameter, 1 mm thickness, and 180 mm height) were filled with approximately 3 grams of the crystallized samples and changes in the solid fat fraction as a function of temperature was measured. Each sample was kept in a water bath set at the specific temperatures (ranging from 5° to 60° C.) for an hour and SFC was measured every 30 minutes. Same measurements were carried out on the control margarine. The reported data correspond to the average of three individual measurements.

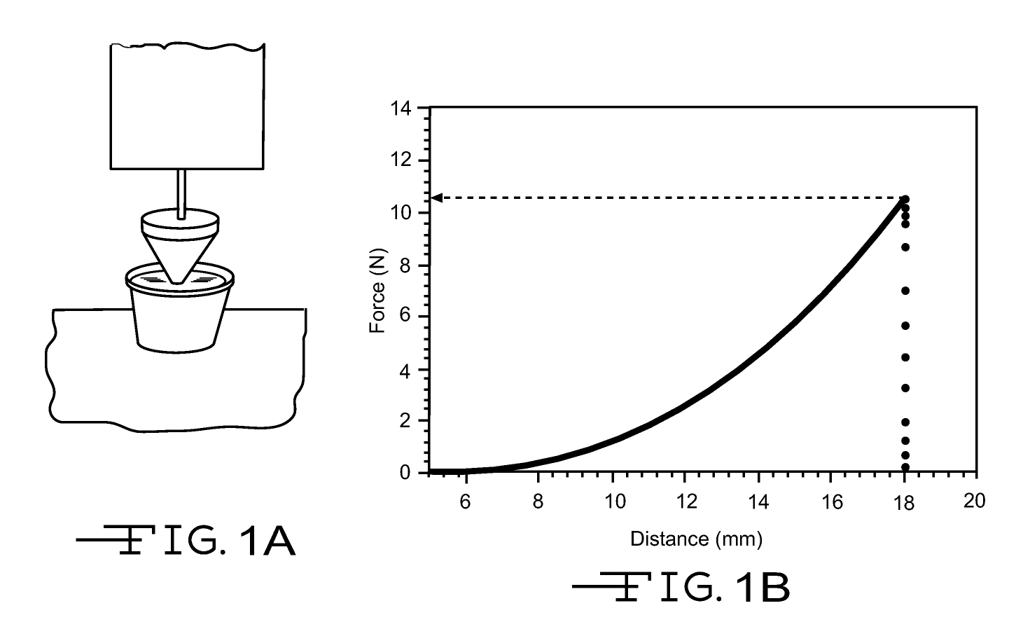

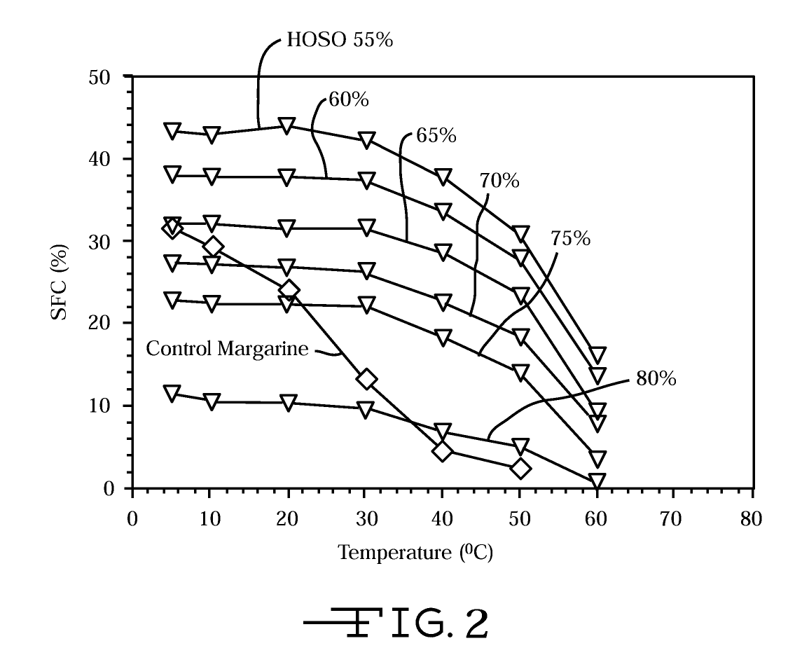

Evaluation of the Samples' Hardness: A Stable Micro Systems material tester (model SMS TA XT plus, Texture Analyzer), with a 5-kg load cell, was used to measure the penetration depth of the specimens. As illustrated in FIG. 1A, the texture analyzer included a cone of penetrometry for measuring the penetration. The cone, which was a conical probe at a temperature of 45C, was introduced to the blends at a constant rate of 1 mm/s to a penetration depth of 9 mm. FIG. 1B shows a plot of force as a function of depth of penetration which results in the maximum force of penetration. The force displacement diagram was obtained by plotting the applied force against distance. As demonstrated in this figure, once the trigger force was attained, the applied force was increased until the maximum penetration distance was reached. Using the Texture Exponent software (Stable Micro System Ltd., Golaming, Surrey, UK), the force displacement graph was fit and the maximum force, the force at which the probe was at its maximum penetration depth, was recorded. The temperature of the samples during the test was 5° C. and all the measurements were done in triplicate. The described penetration test was also performed on the control margarine and its penetration curved was reported.

Results and Discussion:

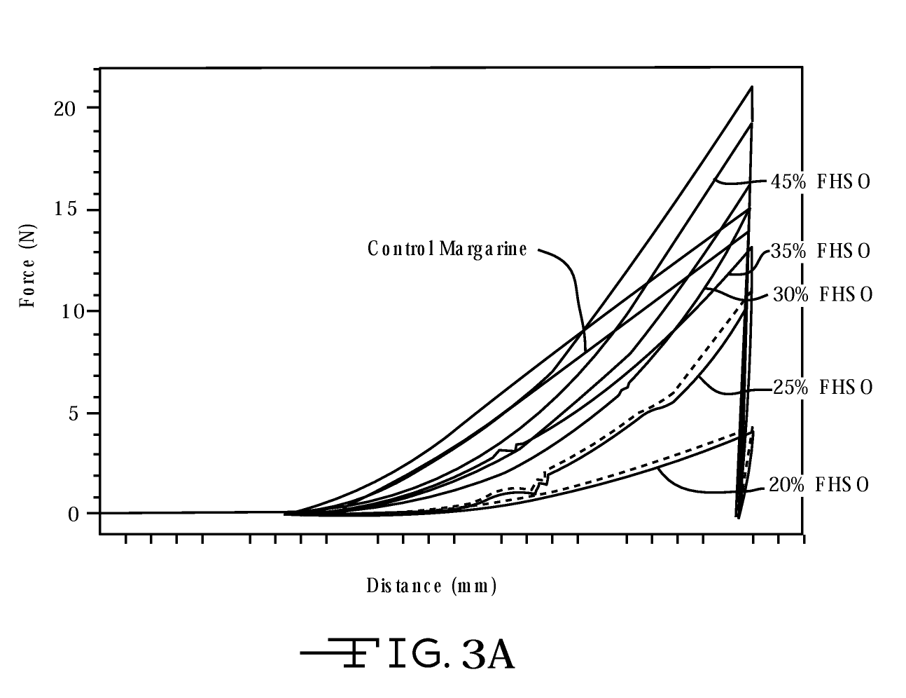

The SFC profiles of the crystallized blends and the commercial margarine as a function of temperature are reported in FIG. 2. As expected the amount of solid fat is dependent on the amount of FHSO, and increasing the oil mass fraction caused a gradual decrease in the solid fat contents of the blends. Not surprisingly the SFC reduction was not proportional to the decrease in FHSO ratio, expected based on the dilution arguments. For instance in the blend of 45 and 20% FHSO, the SFC values were 43 and 12%, respectively. This could be explained based on the solubility of the solid fat in the liquid oil that may lead to different crystallization behavior and structural characteristics of the mixtures. The solubility is higher in blends with higher concentration of oil, resulting in lower amount of solid.

Comparing the SFC vs. temperature profile of the blends with that of the control margarine, mixture prepared with 65 and 70% HOSO showed a total fat more similar to that of the control margarine at lower temperatures. However, a closer look at FIG. 2 reveals that the amount of solid fat in these samples does not decrease linearly as a function of temperature. When all the mixtures displayed a plateau of SFC at lower temperatures followed by a gradual decrease after 40° C., there was a fast drop of SFC after 30° C. in the control margarine. This observation suggests further analysis of the results and possible modifications of the processing and formulations. It is well known that the amount of crystallized solid is not only governed by the blends formulation, but also by the crystallization temperature and the processing condition. For instance different SFC profiles may be observed if the blends are solidified under different rates of cooling. Furthermore, it is worth noting that the functional and physical properties of fats are not only related to the amount of solid fat volume. The macroscopic characteristics of fats are the result of the combined effects of solid fat contents and the micro and nano-structure of the fat crystal networks, including the shape, size and the crystalline distributions.

In order to further explore this idea and also the possibility of margarine production from a binary mixture of fully hydrogenated soybean oil and high oleic soybean oil, the textural properties of the blends were also determined.

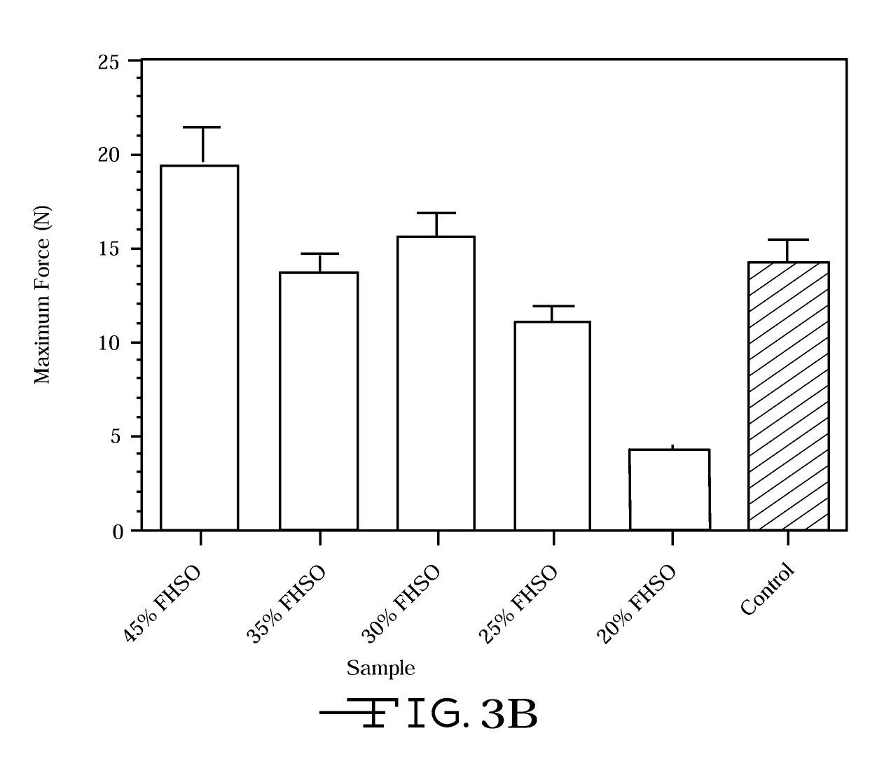

FIG. 3 presents the plot of the maximum force, referred to as “hardness” of the samples, versus the volume fraction of the fully hydrogenated soybean oil. FIG. 3(A) is a plot of penetration force as a function of penetration depth for all the crystallized blends and the control margarine. FIG. 3(B) is a comparison of all the blends' hardness with the hardness of the control margarine. The figure illustrates that increasing the FHSO ratio, the saturated fat with high melting point, is positively correlated with increasing the samples hardness in the range studied. This could be expected since the penetration force is a strong function of the matrix solid fat content. Comparing the blends' hardness with the control margarine, a much higher maximum force was recorded for the sample of 45% FHSO and a significant decrease of penetration force was observed after the addition of 80% HOSO. As demonstrated in the figure, two of the blends (30% and 35% of solid FHSO) had a penetration force similar to that of the control margarine. The control margarine has a maximum penetration force of 14.5N when the values are 13.7 and 15.5N for blend of 30 and 35% solid fat, respectively. Interestingly the calculated hardness was lower in the mixture of 35% FHSO with a higher amount of solid. This observation confirms that the mechanical properties of the fats are not only governed by the amount of solid fat but also by the effects of other structural properties. One may also notice that decreasing the amount of fully hydrogenated soybean oil in the dilution by just 5%, lowers the system hardness dramatically. A clear evidence for this is the significant drop of hardness from 25% to 20% FHSO.

These results show that blends of fully hydrogenated soybean oil and high oleic soybean oil can be used for the production of margarines. The blends were shown to have properties similar to a control margarine.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A candle including a candle wax in the form of a candle and a wick disposed in the wax, the candle wax comprising:
a triacylglycerol component produced by partial hydrogenation of a triacylglycerol feedstock, the triacylglycerol feedstock having a monounsaturated fatty acid content of at least 22% and a polyunsaturated fatty acid content of not greater than 63%, and the partially hydrogenated triacylglycerol component having a polyunsaturated fatty acid content of not greater than 3%.

2. The candle of claim 1 wherein the partially hydrogenated triacylglycerol component has a saturated fatty acid content within a range from 20% to 30% and a monounsaturated fatty acid content within a range from 70% to 80%.

3. The candle of claim 1 wherein the triacylglycerol feedstock has a polyunsaturated fatty acid content of not greater than 10%.

4. The candle of claim 1 wherein the partially hydrogenated triacylglycerol component has a diunsaturated fatty acid content of not greater than 2% and a triunsaturated fatty acid content of not greater than 1%.

5. The candle of claim 1 wherein the triacylglycerol feedstock comprises an oil having an oleic acid content of at least 60%, the oil being derived from a source selected from the group consisting of soybean, canola, palm, olive, peanut, sesame, sunflower, safflower, algae, and combinations thereof.

6. The candle of claim 5 wherein the oil comprises a high oleic soybean oil.

7. The candle of claim 1 wherein the partially hydrogenated triacylglycerol component has an iodine value within a range from 45 to 70.

8. The candle of claim 1 wherein the partially hydrogenated triacylglycerol component has a fatty acid composition of 10-20% stearic, 5-15% palmitic, 50-80% oleic, 0.1-2% linoleic and 0.1-1% linolenic.

9. The candle of claim 1 wherein the partially hydrogenated triacylglycerol component has a melting temperature within a range from 0° C. to 70° C. and a crystallization temperature within a range from −15 ° C. to 45° C.

10. The candle of claim 1 wherein the partially hydrogenated triacylglycerol component has a softness index within a range from 0.005 lbf to 0.505 lbf.

11. A triacylglycerol based composition comprising:
a triacylglycerol component produced by full hydrogenation of a triacylglycerol feedstock; and
a softener blended with the triacylglycerol component to decrease the hardness of the triacylglycerol based composition, the softener being an oil which is a monoglyceride, diglyceride or triglyceride, the fatty acids of the oil being saturated or mono-unsaturated;
the triacylglycerol based composition having a saturated fatty acid content within a range of 20% to 30% and a monounsaturated fatty acid content within a range of 60% to 80%.

12. The composition of claim 11 wherein the triacylglycerol feedstock before hydrogenation has an oleic acid content of at least 60%, a saturated fatty acid content of not greater than 30%, and a polyunsaturated fatty acid content of not greater than 10%.

13. The composition of claim 11 wherein the triacylglycerol based composition has a trans fatty acid content of not greater than 0.5%.

14. The composition of claim 11 wherein the triacylglycerol feedstock comprises a high oleic soybean oil.

15. The composition of claim 11 wherein the softener decreases the hardness of the triacylglycerol based composition by an amount within a range of 5% to 50%.

16. The composition of claim 11 wherein the softener comprises a short chain triglyceride.

17. The composition of claim 16 wherein the short chain triglyceride is selected from triacetin, tributyrin, tripropionin, and combinations thereof.

18. The composition of claim 11 wherein the softener comprises a fatty acid ester.

19. The composition of claim 18 wherein the fatty acid ester is selected from ethylhexyl stearate, ethylhexyl palmitate, ethylhexyl laurate, and combinations thereof.

20. The composition of claim 11 wherein the softener comprises a high oleic plant oil.
